(19) United States
(12) Patent Application Publication
(10) Pub. No.: US 2016/0247168 A1
(43) Pub. Date: Aug. 25, 2016

(54) SYSTEM AND METHOD FOR MONITORING AND REPORTING ENVIRONMENTAL CONDITIONS

(71) Applicant: Frank Pappalardo, Coventry, CT (US)

(72) Inventor: Frank Pappalardo, Coventry, CT (US)

(21) Appl. No.: 15/049,535

(22) Filed: Feb. 22, 2016

Related U.S. Application Data
(60) Provisional application No. 62/118,906, filed on Feb. 20, 2015.

(51) Int. Cl. G06Q 30/00; G06F 17/30

(52) U.S. Cl. CPC G06Q 30/018; G06F 17/30241

(57) ABSTRACT

A method for identifying, monitoring, collecting and collating compliance information regarding safety components of a defined environment, is provided and includes securely associating a location tag with at least one location within the defined environment, wherein the location tag is configured to include location information regarding the at least one location, obtaining at least a portion of the location information, associating the at least a portion of the location information with the location tag, uploading the at least a portion of the location information into a processing device, processing the at least a portion of the location information via the processing device to generate processed location information and publishing the processed location information in a predetermined format.

### RELATED APPLICATIONS

This application is related to and claims the benefit of U.S. Provisional Patent Application Ser. No. 61/118,906 (Atty. Docket No. PAP-0001-P), entitled System and Method for Monitoring and Reporting Environmental Conditions and filed Feb. 20, 2015, the contents of which are incorporated herein by reference in its entirety.

### FIELD OF THE INVENTION

This invention relates generally to a system for identifying and tracking safety compliance issues related to building safety systems and more particularly to a system and method for monitoring and tracking compliance issues related to life-safety and maintenance building equipment and components.

### BACKGROUND OF THE INVENTION

As is known, various regulatory agencies, such as the Occupational Safety and Health Administration (OSHA), the National Fire Protection Association (NFPA), as well as other state and local building, fire and health departments issue regulations that public and private facilities and building owners/operators need to comply with in order to remain open and operating. Additionally for health care facilities the Joint Commission for Health Care Facilities (JCHCF) which is critical for proper accreditation. These regulations include providing alarms, safety doors, fire and smoke suppression equipment and easy egress capability from these buildings. Compliance with these regulations require documentation of the equipment and/or location of the area for inspection, the standard to which the equipment and/or location inspected need to comply, any existing conditions or anomalies existing with the equipment and/or location being inspected, as well as any portable and/or fixed devices/appliances servicing the location and whether any corrective actions are needed to bring the equipment and/or location to compliance. Additionally, these inspections are typically required on a scheduled basis with proper report documentation to show that the equipment and areas of interest are regularly monitored and kept up to compliance with the regulations.

Unfortunately however, some health facilities, schools, universities and public buildings and the like have hundreds of locations and/or equipment that need to be inspected and updated to comply with the regulations. As such, the task of monitoring and documenting (i.e. keeping track of status and updates) can be a difficult and laborious task which requires a large staff and hundreds of man hours of work. This increases the chance of errors in documentation and equipment upkeep with can threaten compliance.

### SUMMARY OF THE INVENTION

A method for identifying, monitoring, collecting and collating compliance information regarding safety components of a defined environment, is provided and includes securely associating a location tag with at least one location within the defined environment, wherein the location tag is configured to include location information regarding the at least one location, obtaining at least a portion of the location information, associating the at least a portion of the location information with the location tag, uploading the at least a portion of the location information into a processing device, processing the at least a portion of the location information via the processing device to generate processed location information and publishing the processed location information in a predetermined format.

A method for identifying, monitoring, collecting and collating compliance information regarding safety components of a defined environment, is provided and includes associating a location tag with at least one location within the defined environment, wherein the location tag is configured to include location information regarding the at least one location, obtaining at least a portion of the location information, associating the at least a portion of the location information with the location tag, uploading the at least a portion of the location information into a processing device, processing the at least a portion of the location information via the processing device to generate processed location information and publishing the processed location information in a predetermined format.

A system for implementing a method for identifying, monitoring, collecting and collating compliance information regarding safety components of a defined environment is provided and includes a location tag configured to identify a predefined location, a location tag reading device configured to read location information associated with the location tag and a processing device, wherein the processing device is configured to receive the location information and process the location information to generate processed location information.

### BRIEF DESCRIPTION OF THE DRAWINGS

The foregoing and other features and advantages of the present invention will be more fully understood from the following detailed description of illustrative embodiments, taken in conjunction with the accompanying drawings in which like elements are numbered alike:

FIG. 1 is a schematic block diagram of a Compliance Monitoring System (CMS), in accordance with one embodiment of the invention.

FIG. 2 is a schematic block diagram illustrating a general computer system for implementing a method for efficiently identifying, monitoring, collecting and collating compliance information regarding safety systems of a building or other establishment, in accordance with one embodiment of the invention.

FIG. 3 is an operational block diagram illustrating a method for efficiently identifying, monitoring, collecting and collating compliance information regarding safety systems of a building or other establishment, in accordance with an embodiment of the invention.

FIG. 4 is an operational block diagram illustrating a method for efficiently identifying, monitoring, collecting and/or collating compliance information for Life-Safety equipment, building, and structure components, in accordance with another embodiment of the invention.

### DETAILED DESCRIPTION OF THE INVENTION

As disclosed herein with regards to an exemplary embodiment, the present invention provides a system and method for efficiently identifying, monitoring, collecting and collating compliance information regarding safety and maintenance systems of a building or other establishment.

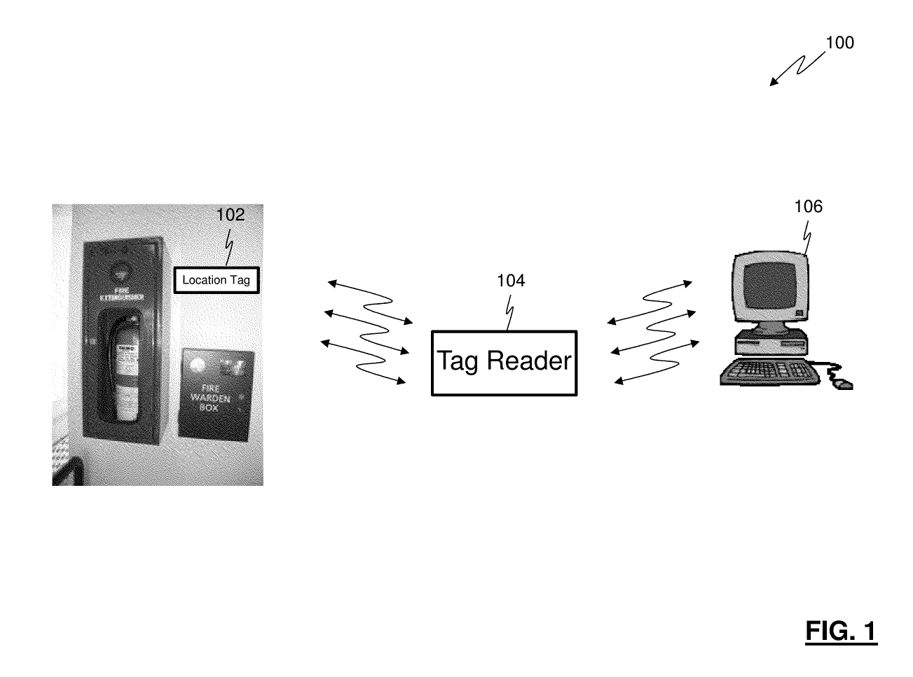

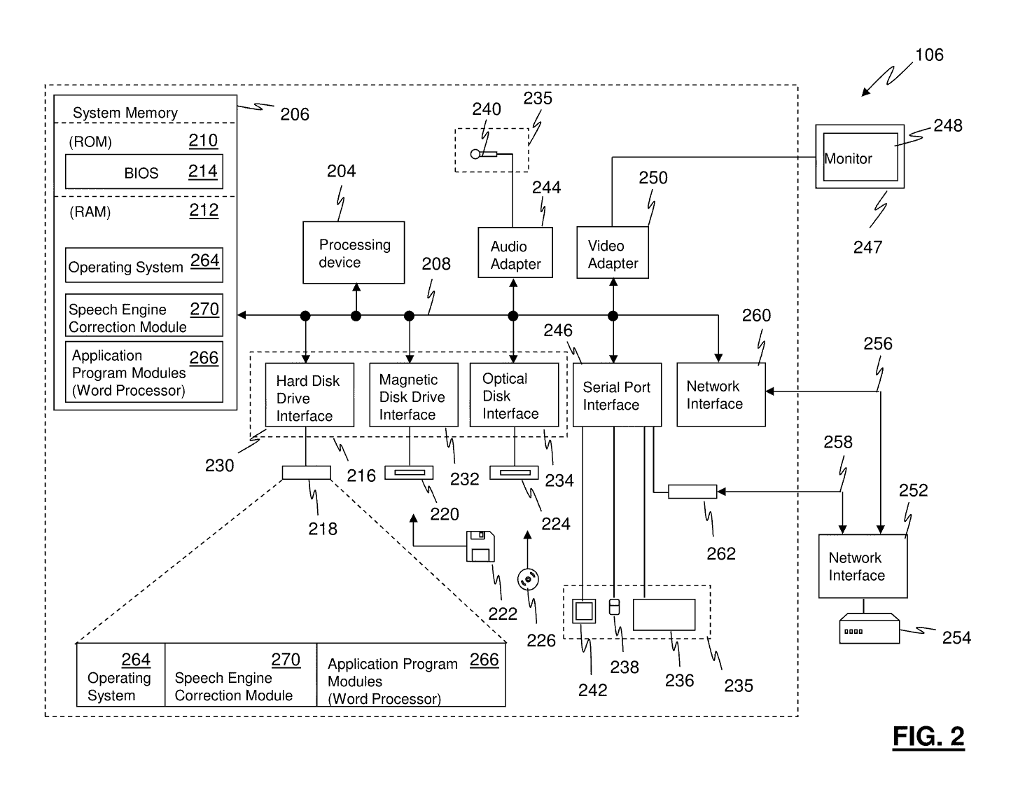

Referring to the FIG. 1, a schematic block diagram of a Compliance Monitoring System (CMS) 100 is illustrated and includes a plurality of location tags 102, at least one location tag reader 104 and a general computing device 106 having a processing device communicated with a storage device, wherein each location that requires monitoring includes at least one location tag 102. One embodiment of a general computing device 106 is shown in FIG. 2. It should be appreciated that the storage device may include a database which may include information (standards, history, outstanding actions, etc . . . ) regarding each specific location. Moreover, it is contemplated that the location tag reader 104 may be configured to communicate with the location tags 102 via any method suitable to the desired end purpose, such as, but not limited to, RFID (Radio-Frequency Identification), Bluetooth, WiFi, Optical Transmission, and/or hardwire connection (via a plug-in). Additionally, the type of location and information to be monitored may include Fire Extinguisher: locations, type, projected replacement timeline; Fire Doors: conditions, clearance, door alarm; Fire Dampers; Exit and Emergency lights; Wall/Floor/Roof penetrations; HVAC filters and air handlers; Kitchen Exhaust Systems and Grease Ducts; and Emergency Power Generators, just to name a few.

It should be appreciated that each location/device/area may include unique specific information about that location/device/area that needs to be monitored, tracked and, in some cases, acted upon and updated. This information may be stored for those locations on the location tags 102 (either partially or wholly) and/or on a database on the general computing device 106 and/or tag reader 104 which corresponds to the unique location tags 102. For example, if a Fire Extinguisher at one or more locations need to be replaced or recharged, this information would be located in the database and/or the location tag 102. An inspector conducting inspections, would approach one or more locations and communicate with the location tags 102 using the location tag reader 104. The inspector would enter notations regarding the conditions of the location/device/area into the location tag reader 104. When the inspector completes the required inspections, the notations may be uploaded into the database, where the notations may be combined with the appropriate data for particular locations/devices/areas.

Referring to FIG. 2, a block diagram illustrating a general computing device (and system) 106 for implementing a method for efficiently identifying, monitoring, collecting and collating compliance information regarding safety systems is shown and includes a processing device 204, a system memory 206, and a system bus 208, wherein the system bus 208 couples the system memory 206 to the processing device 204. The system memory 206 may include read only memory (ROM) 210 and random access memory (RAM) 212. A basic input/output system 214 (BIOS), containing basic routines that help to transfer information between elements within the general computer system 202, such as during start-up, is stored in ROM 210. The general computer system 202 further includes a storage device 216, such as a hard disk drive 218, a magnetic disk drive 220, e.g., to read from or write to a removable magnetic disk 222, and an optical disk drive 224, e.g., for reading a CD-ROM disk 226 or to read from or write to other optical media and/or solid-state drive (SDD). The storage device 216 may be connected to the system bus 208 by a storage device interface, such as a hard disk drive interface 230, a magnetic disk drive interface 232 and an optical drive interface 234. The drives and their associated computer-readable media provide nonvolatile storage for the general computer system 202. Although the description of computer-readable media above refers to a hard disk, a removable magnetic disk and a CD-ROM disk, it should be appreciated that other types of media that are readable by a computer system and that are suitable to the desired end purpose may be used, such as magnetic cassettes, flash memory cards, digital video disks, Bernoulli cartridges, SSDs and the like.

A user may enter commands and information into the general computer system 106 through a conventional input device 235, including a keyboard 236, a pointing device, such as a mouse 238 and/or a microphone 240, wherein the microphone 240 may be used to enter audio input, such as speech, into the general computer system 202. Additionally, a user may enter graphical information, such as drawings or hand writing, into the general computer system 106 by drawing the graphical information on a writing tablet 242 using a stylus or photographs. The general computer system 106 may also include additional input devices suitable to the desired end purpose, such as a joystick, game pad, satellite dish, scanner, or the like. The microphone 240 may be connected to the processing device 204 through an audio adapter 244 that is coupled to the system bus 208. Moreover, the other input devices are often connected to the processing device 204 through a serial port interface 246 that is coupled to the system bus 208, but may also be connected by other interfaces, such as a game port or a universal serial bus (USB).

A display device 247, such as a monitor or other type of display device 247, having a display screen 248, is also connected to the system bus 208 via an interface, such as a video adapter 250. In addition to the display screen 248, the general computer system 202 may also typically include other peripheral output devices, such as speakers and/or printers. The general computer system 106 may operate in a networked environment using logical connections to one or more remote computer systems 252. The remote computer system 252 may be a server, a router, a peer device or other common network node, and may include any or all of the elements described relative to the general computer system 204, although only a remote memory storage device 254 has been illustrated in FIG. 2. The logical connections as shown in FIG. 2 include a local area network (LAN) 256 and a wide area network (WAN) 258. Such networking environments are commonplace in offices, enterprise-wide computer networks, intranets and the Internet.

When used in a LAN networking environment, the general computer system 106 is connected to the LAN 256 through a network interface 260. When used in a WAN networking environment, the general computer system 106 typically includes a modem 262 or other means for establishing communications over a WAN 258, such as the Internet. The modem 262, which may be internal or external, may be connected to the system bus 208 via the serial port interface 246. In a networked environment, program modules depicted relative to the general computer system 202, or portions thereof, may be stored in the remote memory storage device 254. It should be appreciated that the network connections shown are exemplary and other means of establishing a communications link between the computer systems may be used. It should also be appreciated that the application module could equivalently be implemented on host or server computer systems other than general computer systems, and could equivalently be transmitted to the host computer system by means other than a CD-ROM, for example, by way of the network connection interface 260.

Furthermore, a number of program modules may be stored in the drives and RAM 212 of the general computer system 106. Program modules control how the general computer system 106 functions and interacts with the user, with I/O devices or with other computers. Program modules include routines, operating systems 264, target application program modules 266, data structures, browsers, and other software or firmware components. The method of the present invention may be included in an application module and the application module may conveniently be implemented in one or more program modules, such as a speech engine correction module 270 based upon the methods described herein.

It should be appreciated that no particular programming language is described for carrying out the various procedures described in the detailed description because it is considered that the operations, steps, and procedures described and illustrated in the accompanying drawings are sufficiently disclosed to permit one of ordinary skill in the art to practice an exemplary embodiment of the present invention. Moreover, there are many computers and operating systems which may be used in practicing an exemplary embodiment, and therefore no detailed computer program could be provided which would be applicable to all of these many different systems. Each user of a particular computer will be aware of the language and tools which are most useful for that user's needs and purposes.

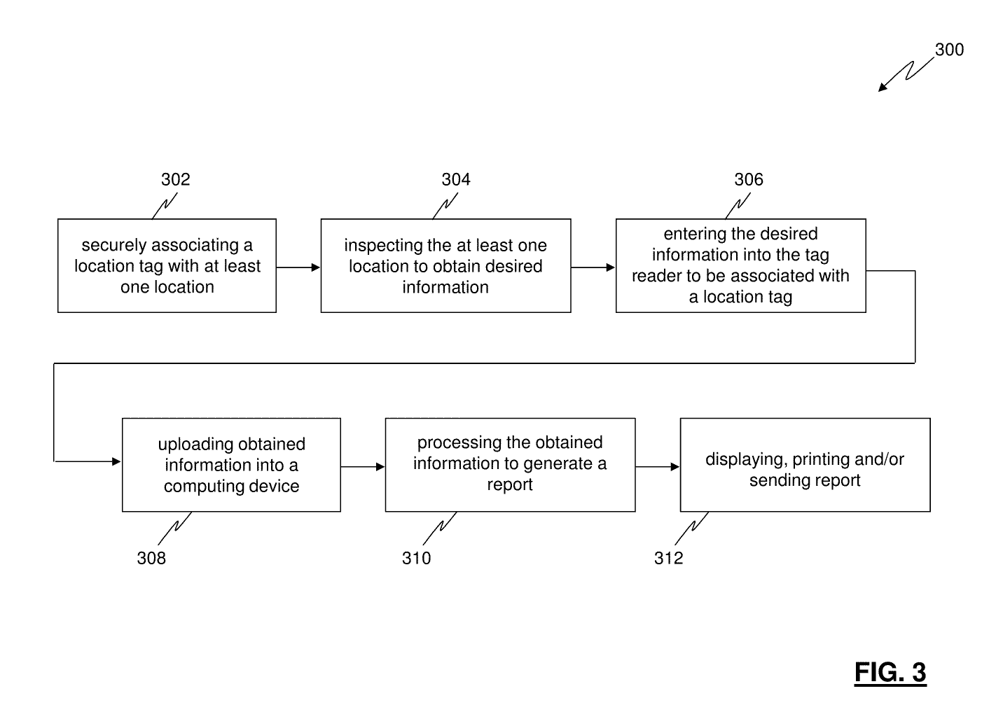

Referring to FIG. 3, one embodiment of a method 300 for efficiently identifying, monitoring, collecting and collating compliance information regarding safety systems of a building or other establishment is illustrated and includes securely associating a location tag 102 with at least one location, as shown in operational block 302. It should be appreciated that this location tag 102 may be configured to include any information as desired. For example, information regarding the location to be monitored, such as geographical location, physical condition of location/device/area, special instructions to follow during inspection, etc. The method further includes physically and/or visually inspecting a desired location to obtain desired information regarding the location, as shown in operational block 304. For example, if the location includes fire doors and fire extinguishers, then it should be appreciated that this desired information may include checking to see if fire doors have a clear path for egress, whether the fire doors are operating as desired and/or whether the fire extinguishers are up to date and charged. Once the inspection of the location is complete (and/or during the inspection), the information obtained may be entered into the tag reader 104 such that the information is associated with the location tag 102 (and thus, the location), as shown in operational block 306. Each site that has been identified as requiring inspection may then be inspected and data obtained and stored within the tag reader 104 as discussed hereinabove.

The method 300 further includes uploading the obtained information to the computing device 106, as shown in operational block 308. Once uploaded, the processing device 204 may process the information to generate a report, as shown in operational block 310. It should be appreciated that the processing device 204 may analyze and/or compare the information, based on one or more algorithms, to applicable compliance standards and highlight the results in the report, wherein the report may include a summary of the inspections that were conducted, what the inspections involved, the status of compliance to applicable standards, any compliance issues that were identified, any up-coming maintenance/repair issues, etc. Additionally, the report may provide a suggested course of action in order to address any identified issues. Once generated, the report may be displayed on a display device, printed into a report format and/or automatically sent to desired individuals, as shown in operational block 212.

In accordance with another embodiment, the CMS 100 may advantageously have the ability to perform self-diagnostics in order to identify any potential issues before they arise.

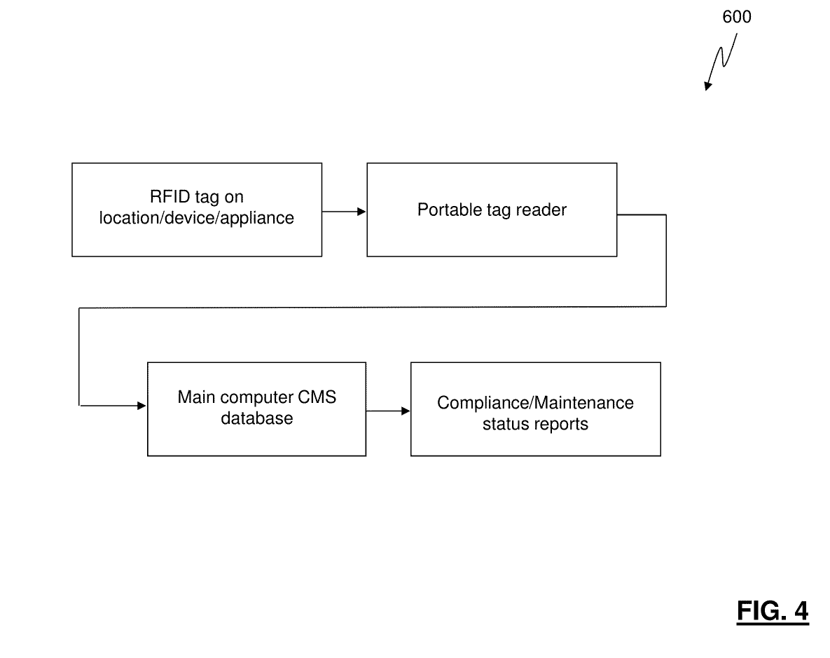

In accordance with another embodiment, referring to FIG. 4, a Compliance Monitoring System (CMS) that provides a system and method 600 for efficiently identifying, monitoring, collecting and/or collating compliance information for Life-Safety equipment, building, and structure components is provided. Components and/or locations are identified and the specific information exclusive to each location/device/appliance is established and entered in a computing device, such as a main computer CMS database. This information may include: location, design specifications, operating procedures, regulatory compliance information, maintenance procedures, etc. The main computer may have the capability to provide (upload & download) the appropriate data to a portable handheld device equipped with a radio frequency identification tag (RFID) reader. A unique RFID tag may be affixed to each location/device/appliance and coupled to its associated specific information on the CMS database. (These RFID tags may include active, semi-active and passive RFID tags).

Using the handheld device an inspector, when on site, can view the specifications and document any anomalies or corrective actions needed by way of drop-down menus and/or comment fields. The resulting information may then be up-loaded by means of hard-wire, WAN, LAN, Wi-Fi, cell network, Bluetooth, etc. to the main computer CMS database. The CMS database may analyze and/or compare the information and history, based on one or more algorithms, to applicable compliance standards and highlight the results in the report, wherein the report may include a summary of the inspections that were conducted, what the inspections involved, the status of compliance to applicable standards, any compliance issues that were identified, any up-coming maintenance/repair issues, etc. Enhancements to the CMS may include facility location mapping on Computer-aided design (CAD) drawings, Global Positioning System (GPS) or similar advantages.

It should be appreciated that some potential areas for CMS use may include: Fire Extinguisher: locations, type, projected replacement timeline Fire Doors Fire Dampers Exit and emergency lights Wall/Floor/Roof penetrations HVAC filters and air handling Kitchen exhaust systems and grease ducts Emergency power generators and/or any other area/location where it would be desirable to monitor and document.

It should be appreciated that the CMS may be configured to operate based on inspections and/or information supplied via inspection. For example, in one embodiment, the CMS may be configured to generate/communicate work orders when inspection identifies unsafe and/or non-compliant conditions. Additionally, the CMS may be configured to track resolution of the unsafe and/or non-compliant conditions and/or generate/communicate resolution documentation upon resolution of the unsafe and/or non-compliant conditions.

Additionally, a machine-readable computer program code and/or a medium encoded with a machine-readable computer program code for implementing the method 300 may be provided. Moreover, in accordance with another embodiment, the method of FIG. 3 and FIG. 4 may be implemented by a controller disposed internal, external or internally and externally to CMS 100. In addition, processing of FIG. 3 and FIG. 4 may be implemented through a controller operating in response to a computer program. In order to perform the prescribed functions and desired processing, as well as the computations therefore (e.g. execution control algorithm(s), the control processes prescribed herein, and the like), the controller may includes, but not be limited to, a processor(s), computer(s), memory, storage, register(s), timing, interrupt(s), communication interface(s), and input/output signal interface(s), as well as combination comprising at least one of the foregoing.

The invention may be embodied in the form of a computer or controller implemented processes. The invention may also be embodied in the form of computer program code containing instructions embodied in tangible media, such as floppy diskettes, CD-ROMs, hard drives, and/or any other computer-readable medium, wherein when the computer program code is loaded into and executed by a computer or controller, the computer or controller becomes an apparatus for practicing the invention. The invention can also be embodied in the form of computer program code, for example, whether stored in a storage medium, loaded into and/or executed by a computer or controller, or transmitted over some transmission medium, such as over electrical wiring or cabling, through fiber optics, or via electromagnetic radiation, wherein when the computer program code is loaded into and executed by a computer or a controller, the computer or controller becomes an apparatus for practicing the invention. When implemented on a general-purpose microprocessor the computer program code segments may configure the microprocessor to create specific logic circuits.

While the invention has been described with reference to an exemplary embodiment, it will be understood by those skilled in the art that various changes, omissions and/or additions may be made and equivalents may be substituted for elements thereof without departing from the spirit and scope of the invention. In addition, many modifications may be made to adapt a particular situation or material to the teachings of the invention without departing from the scope thereof. Therefore, it is intended that the invention not be limited to the particular embodiment disclosed as the best mode contemplated for carrying out this invention, but that the invention will include all embodiments falling within the scope of the appended claims. Moreover, unless specifically stated any use of the terms first, second, etc. do not denote any order or importance, but rather the terms first, second, etc. are used to distinguish one element from another.

What is claimed is:

1. A method for identifying, monitoring, collecting and collating compliance information regarding safety components of a defined environment, comprising:
securely associating a location tag with at least one location within the defined environment, wherein the location tag is configured to include location information regarding the at least one location;
obtaining at least a portion of the location information;
associating the at least a portion of the location information with the location tag;
uploading the at least a portion of the location information into a processing device;
processing the at least a portion of the location information via the processing device to generate processed location information; and
publishing the processed location information in a predetermined format.

2. The method of claim 1, wherein location information includes at least one of geographical location, physical condition of location/device/area and any special instruction to follow during inspection of the at least one location.

3. The method of claim 1, wherein obtaining the at least a portion of the location information includes at least one of physically, electronically and visually inspecting the at least one location to identify characteristics of the at least one location.

4. The method of claim 1, wherein associating the at least a portion of the location information with the location tag includes entering the location information into a location tag reading device to be associated with the location tag.

5. The method of claim 1, uploading the at least a portion of the location information into a processing device, includes uploading the at least a portion of the location information into the processing device via a location tag reading device.

6. The method of claim 1, wherein processing the at least a portion of the location information includes at least one of, analyzing the location information responsive to one or more algorithms, and comparing the location information to applicable compliance standards.

7. The method of claim 2, wherein publishing the processed location information includes publishing the processed information to at least one of a visual display device, a hardcopy document and an audio report.

8. A method for identifying, monitoring, collecting and collating compliance information regarding safety components of a defined environment, comprising:
associating a location tag with at least one location within the defined environment, wherein the location tag is configured to include location information regarding the at least one location;
obtaining at least a portion of the location information;
associating the at least a portion of the location information with the location tag;
uploading the at least a portion of the location information into a processing device;
processing the at least a portion of the location information via the processing device to generate processed location information; and
publishing the processed location information in a predetermined format.

9. The method of claim 8, wherein wherein the location tag is configured to include location information regarding the at least one location.

10. The method of claim 8, further comprising uploading the at least a portion of the location information into a processing device.

11. The method of claim 8, wherein obtaining the at least a portion of the location information includes at least one of physically, electronically and visually inspecting the at least one location to identify characteristics of the at least one location.

12. The method of claim 8, wherein associating the at least a portion of the location information with the location tag includes entering the location information into a location tag reading device to be associated with the location tag.

13. The method of claim 8, uploading the at least a portion of the location information into a processing device, includes uploading the at least a portion of the location information into the processing device via a location tag reading device.

14. The method of claim 10, wherein processing the at least a portion of the location information includes processing the location information via the processing device.

15. The method of claim 8, wherein processing the at least a portion of the location information includes at least one of,
analyzing the location information responsive to one or more algorithms, and
comparing the location information to applicable compliance standards.

16. The method of claim 8, wherein publishing the processed location information includes publishing the processed information to at least one of a visual display device, a hardcopy document and an audio report.

17. A system for implementing a method for identifying, monitoring, collecting and collating compliance information regarding safety components of a defined environment, the system comprises:
a location tag configured to identify a predefined location;
a location tag reading device configured to read location information associated with the location tag; and
a processing device, wherein the processing device is configured to receive the location information and process the location information to generate processed location information.

18. The system of claim 17, further comprising an output device configured to publish the processed location information.

19. The system of claim 16, wherein the processing device is configured to process the at least a portion of the location information via at least one of,
analyzing the location information responsive to one or more algorithms, and
comparing the location information to applicable compliance standards.

20. The system of claim 16, wherein the location tag reading device is configured to upload the at least a portion of the location information into the processing device.
